(19) United States
(12) Patent Application Publication
(10) Pub. No.: US 2007/0161039 A1
(43) Pub. Date: Jul. 12, 2007

(54) Method for creating a database enabling the selection of at least one reaction-capable catalyst

(75) Inventors: Alain Wagner, Strasbourg (FR); Cedric Catala, Mundolsheim (FR)

Correspondence Address: OLIFF & BERRIDGE, PLC, P.O. BOX 19928, ALEXANDRIA, VA, 22320, US

(73) Assignee: NOVALYST DISCOVERY, Strasbourg (FR)

(21) Appl. No.: 10/587,336

(22) PCT Filed: Jan. 28, 2005
(86) PCT No.: PCT/FR05/50054

§ 371 Date: Sep. 11, 2006

(30) Foreign Application Priority Data
Jan. 30, 2004 (FR) 04 50178
Jan. 30, 2004 (FR) 04 50172

(51) Int. Cl. C40B 30/02; C40B 40/04

(52) U.S. Cl. 435/7.1; 702/19

(57) ABSTRACT

The invention relates to a method for creating a database enabling, in particular, the selection of at least one reaction-capable catalyst, comprising the following steps: a) preparing a number of different reaction media containing the same reactivity probe and each having at least one catalyst; b) analyzing, by means of an analytic method, each reaction medium after reaction, and; c) assigning, in the database, an analysis result according to step b) to the reactivity probe, this result characterizing different reaction products obtained from said reactivity probe. The database is a relational database containing: a first entity in which items of information relative to the reaction patterns listed in the data base are recorded; a second entity containing items of information relative to the state of bindings of at least one reaction pattern listed in the first entity; a third entity in which items of information associated with different reaction media are stored, and; at least one fourth entity in which items of information are stored that are linked to the analysis results of the reaction media at the end of a reaction.

The present invention relates to the field of catalysis and is aimed in particular at providing a method for creating a database which makes it possible to rapidly identify one or more catalysts which can be used for the conversion of a compound and more particularly of at least one of its reaction units, according to a given chemical reaction.

Organic synthesis by the catalytic route and in particular by heterogeneous catalysis is a synthetic route which is particularly valued industrially. This is because the use of a catalyst generally makes it possible to accelerate the reaction rate, to lower the reaction temperature and/or to increase the yield of the reaction. Furthermore, heterogeneous catalysts, that is to say catalysts which are insoluble in the reaction medium in contrast to “homogeneous” catalysts, have the significant advantage of being easily separated from the reaction products on conclusion of the chemical reaction under consideration.

Unfortunately, at the current time, a simple and fast means for identifying the catalyst(s) capable of displaying the best selectivity and/or effectiveness for a given chemical reaction is not available. Identification of this type of catalyst involves a step which is very often empirical.

Conventionally, a catalyst assumed to be effective is tested as such and, depending on the result obtained, various possibilities can be envisaged. In particular, in the specific case where the catalyst is not satisfactory, either it may be abandoned and another catalyst tested or it may be modified in order to optimize its reactivity. Finally, the operating conditions selected may also be modified. This approach is, of course, time-consuming and therefore expensive.

One alternative consists in taking advantage of “combinatorial” chemistry. According to this approach, a large number of chemical variants of a catalyst assumed to be effective for a given reaction are synthesized and tested in order to characterize the catalyst or catalysts which are the most effective in carrying out the reaction. However, this second approach is not entirely satisfactory. It involves in particular testing, for each new compound to be converted, all the catalysts and creating a new library of catalysts for each new chemical reaction envisaged. This is because the reactivity of the catalysts is not generally archived and even less correlated with a specific structure of the compounds involved in the reaction under consideration and/or with defined reaction conditions. In point of fact, it is known that, for a given catalyst, several degrees of reactivity are capable of existing depending on, on the one hand, the structure of the compounds to be converted and, on the other hand, the reaction conditions and medium selected.

The present invention is targeted in particular at making it possible to rapidly create a database of use in identifying at least one catalyst corresponding to a reaction criterion.

The invention meets this need by virtue of a method for creating a database which makes it possible in particular to select at least one catalyst suitable for a reaction, this method comprising the following stages:
a) preparing a plurality of different reaction media comprising the same reactivity probe and each comprising at least one catalyst,
b) analyzing, by an analytical method, each reaction medium after reaction,
c) assigning a result of the analysis according to stage b) to the reactivity probe in the database, this result characterizing the various reaction products obtained in the reaction medium, if appropriate with their respective yield on this reactivity probe.

The expression “assigning a result of the analysis to the reactivity probe in the database” should be understood as meaning that a connection is established in the base at least between the probe, indeed even the reaction medium, and the result of the analysis. This result can relate to the yield of the reaction products. Such connections can make it possible to convert the results of the analysis in terms of nature and/or of conversion of the reaction units and can thus be of use in replying to a request targeted at determining at least one catalyst with the capability to carry out a conversion of a reaction unit or else to study the influence of the composition of a catalyst and of a reaction medium on its reactivity and its selectivity.

The plurality of different reaction media can comprise at least two reaction media comprising different catalysts. The same reaction media can be used for different probes and are preferably used systematically for different probes.

The analytical method can be a liquid or gas chromatography method.

Stages a) to c) above can be repeated for a plurality of different reactivity probes and/or a plurality of different reaction media.

The term “reaction unit” denotes a unit exhibiting at least one bond or functional group capable of being converted chemically.

This unit can in particular be composed, for example, of a saturated bond of a carbon atom with at least one heteroatom, or an unsaturated bond between two carbon atoms, between a carbon atom and at least one heteroatom or between two identical or different heteroatoms.

The unsaturated bonds between two carbon atoms can, for example, be Cₛₚ hydrocarbon bonds of alkyne type or Cₛₚ₂ hydrocarbon bonds of alkene type.

Within the meaning of the present invention, the term “heteroatom” is intended to cover an atom of nitrogen, of oxygen, of sulfur, of phosphorus, of silicon, of boron, and the like.

Mention may in particular be made, by way of representation and without limitation of reaction units, of the following units: 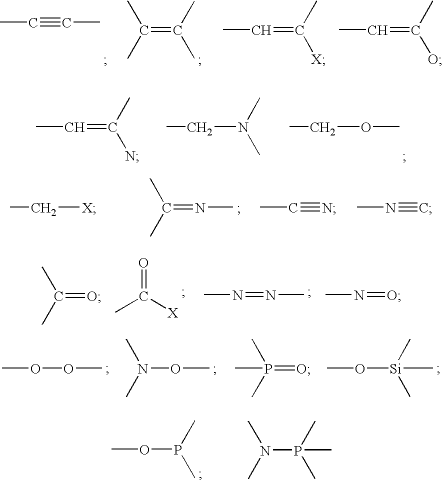
with X representing a halogen atom.

The database can comprise, for each catalyst listed, information relating to the reaction medium and reaction conditions (temperature, pressure, pH, and the like) under which it was tested for its catalytic activity.

The database can individually list the reaction units present on the reactivity probes.

It is possible to associate with each reaction unit listed, at least for a portion of the reaction units listed in the database, information targeted at describing the state of the bonds which are associated with it. It is important to note that the state of the bonds does not in any way predict their reactivity. Thus, the latter is not identical in a reducing or oxidizing medium, or acidic or basic medium, for example.

More specifically, the state of the bonds of a reaction unit can be indexed using an integer, referred to as “state of the bonds”, which can vary from 0 to 3, the value 0 generally describing the absence of a bond and the value 2 characterizing a double bond.

Consequently, each reaction unit/reaction medium pair can be associated with a pair of states of the bonds which can describe the degree of reactivity of said unit before and after its exposure to said reaction medium.

For example, in the event of nonreaction, the original state of the bonds is retained; in the event of reduction, the state of the bonds decreases by at least one unit; (a state equal to zero means the breaking of a bond). A decrease by one unit can correspond, for example, to the conversion of a triple bond into a double bond or of a double bond into a single bond or alternatively to the replacement of a halogen by a hydrogen.

The database is preferably a relational database comprising a first entity in which is recorded information relating to the reaction units listed in the base, a second entity comprising information relating to the state of the bonds of at least one reaction unit listed in the first entity, a third entity in which is recorded information associated with the different reaction media and at least one fourth entity in which is recorded information related to the analytical results of the reaction media on conclusion of a reaction.

For one reactivity probe at least, it is possible to generate a file collating all the results covering all the conversions which have been carried out on said probe.

The database according to the invention can usefully be taken advantage of according to a method which makes it possible to deliver at least one item of information relating to the reactivity of a catalyst with regard to the chemical conversion of at least one reaction unit.

A further subject matter of the present invention is thus a method for creating a database which makes it possible in particular to select at least one catalyst suitable for a reaction, this method comprising the following stages:
a) preparing a plurality of different reaction media comprising the same reactivity probe and each comprising at least one catalyst,
b) analyzing, by an analytical method, each reaction medium after reaction,
c) assigning a result of the analysis according to stage b) to the reactivity probe in the database, this result characterizing the different reaction products obtained from this probe,
   and exhibiting at least one of the following characteristics:
   the database is a relational database comprising a first entity in which is recorded information relating to the reaction units listed in the base, a second entity comprising information relating to the state of the bonds of at least one reaction unit listed in the first entity, a third entity in which is recorded information associated with the different reaction media and at least one fourth entity in which is recorded information related to the analytical results of the reaction media on conclusion of a reaction,
   the reaction units present on the reactivity probes are listed individually in the database for at least a portion of the reaction units, and each unit listed has associated with it information, in particular on the states of the bonds, targeted at describing the degree of reactivity of the bonds which are associated with it,
   the database comprises information which informs about the influence of the structural environment of a listed reaction unit on its reactivity.

A further subject matter of the present invention, according to one of its aspects, is a method for delivering at least one item of information relating to the reactivity of a catalyst with regard to a chemical conversion of at least one reaction unit, it being possible for this method to be characterized in that it comprises at least the stages consisting in:
x) acquiring data relating to said conversion and, if appropriate, to the structural environment of the reaction unit to be converted,
y) identifying, in a database informing about the reactivity of a group of catalysts with regard to reaction units listed in the database and present on reactivity probes, at least one listed reaction unit related to the unit to be converted,
z) selecting, in the database, according to the listed reaction unit thus identified, on the one hand, and the conversion to be carried out, on the other hand, at least one catalyst having the reactivity required for the conversion.

The expression “listed reaction unit related to the unit to be converted” should be understood as meaning that the reaction unit listed in the database is identical to the reaction unit to be converted or sufficiently close structurally for it to be possible to believe that the catalyst which will be selected is of use in the conversion to be carried out. Its reactivity can be equivalent to that of the unit to be converted and is reflected by the expected chemical conversion or by an equivalent chemical conversion.

The term “structural environment” is intended to denote the environment resulting from the combination and from the spatial arrangement of the group of the reaction units constituting the same molecular entity.

The reactivity of a reaction unit is capable of varying significantly according to whether or not it possesses other reaction units in its immediate structural environment. For example, an ethylenic functional group, according to whether it is positioned in the a position with respect to a ketone functional group or to a methylene unit, will not display the same degree of reactivity during a catalytic hydrogenation or nucleophilic addition reaction.

The database can comprise information which informs about the influence of the structural environment of a listed reaction unit.

That the reaction units listed belong to reactivity probes which can comprise several reaction units makes it possible to take into consideration, where appropriate, the “reactional influence” aspect for the selection of the catalysts, that is to say the influence experienced by a reaction unit in terms of reactivity due to its associated structural environment.

By definition, the object of a reaction is to convert, assemble and/or dissociate one or more reaction units from a compound without, if appropriate, modifying other units also present. The expressions “chemical conversion” and “chemical reaction” encompass not only “conventional” chemistry but also biochemistry, and the conversion or reaction can be biological.

Generally, the chemical reactions which can occur in the reaction media are reactions for the formation or breaking of bonds, in particular C—C, C—O, C—N, C═N or C═C bonds.

Mention may in particular be made, by way of representation and without implied limitation of chemical reactions, of halogenation, reduction, hydrogenation, in particular by the heterogeneous catalytic route, oxidation, hydrolysis, dehydration and esterification reactions.

The reactions considered according to the invention can thus be acidic catalytic reactions, such as, for example, protection/deprotection reactions, basic catalytic reactions, metal-catalyzed multicomponent reactions, trimerization reactions, reactions for the formation of heterocycles, for example, pericyclic reactions, or thermal and/or photochemical reactions.

The term “conversion” denotes a reaction located at a reaction unit. This term encompasses any type of conversion, assembling or dissociation, insofar as it is located at a reaction unit. The conversion of a reaction unit can be the formation of a coupling of two identical or different reaction units.

Mention may in particular be made, by way of illustration of conversions capable of taking place in a hydrogenation reaction, of the following conversions: reduction of imine to give amine, cleavage of a benzyl C—N or C—O bond, reduction of a halide, of a nitro functional group to give amine or of a nitrile to give amine, reduction of amide, reduction of an alkyne unit, reduction of a ketone to give alcohol, reduction of a ketone to give alkane and cleavage of an ether unit.

The acquisition of stage x) can, for example, be a capture using a keyboard or a graphics tablet or the reception of data, for example a file.

In what follows, the term “capture” or “acquisition” will be used independently.

The capture of the data in stage x) above can comprise the formulation of a request mentioning the reaction unit concerned and the nature of the conversion to which it is desired to subject it.

The conversion can be formulated by using the name of the conversion, for example by selecting it from a list appearing on a drop-down menu. The conversion can also be formulated by indicating the variation in the state of the bonds of the functional groups to be converted or to be retained at each reaction unit resulting from the conversion or the difference in the state of the bonds in the reaction unit under consideration between the states before and after conversion.

If appropriate, the capture of the data can comprise the formulation of a request relating to the conversion and/or the nonconversion of at least two different reaction units.

In the case, for example, of a first reaction unit to be converted and of a second reaction unit not to be converted, these first and second reaction units being present on a starting compound, the request can target the selection of a catalyst capable of carrying out the conversion of the first unit with a satisfactory yield while leaving the second intact or at the very least converting it to a sufficiently insignificant extent.

The capture of the data in stage x) can also be carried out by formulating a request for the conversion of at least one starting compound.

In this case, the method can comprise the analysis of the starting and final compounds for the purpose of identifying the reaction unit or units which react and that or those which do not react. In the light of this or these reaction units which react and/or do not react, at least one new request relating to at least one reaction unit of the starting compound can be formulated. This request can, if appropriate, be formulated automatically, just as the abovementioned analysis can be carried out without the involvement of the user, apart from confirming, if appropriate, the analysis carried out automatically.

Thus, the method according to the invention can involve:
the breakdown into different substructures of a starting compound involved in a reaction,
the identification of the reaction unit or units to be converted and, if appropriate,
the identification of the reaction unit or units which have to be retained.

The capture of the starting compound and of the final compound can be carried out, for example, by drawing their structure, by giving their name or an identifier referring to their structure.

The capture of the data in stage x) can be carried out via a computer network, in particular the Internet or the Intranet. In this event, the intervention of the user can, for example, be limited to specifying the identity of the starting and final compounds.

As indicated above, a plurality of reaction units listed in the database are present on reactivity probes. The reactivity probes used can more particularly be suitable for a given type of reaction.

At least some of the reaction data recorded in the database have been acquired by reacting the reactivity probes. The latter have, in their structure, at least one reaction unit capable of being converted according to a catalytic chemical reaction, this reaction unit being, for example, chosen from those cited above.

The reactivity probes can be natural or synthetic. They can in particular be low-weight hydrocarbon molecules which can comprise from 10 to 30 carbon atoms. They can be saturated or unsaturated and linear or branched.

Generally, each reactivity probe comprises at least one reaction unit in a specific structural environment. They advantageously comprise at least two different reaction units or at least three reaction units, including at least two different units, or even at least four reaction units, including at least two, indeed even at least three, different units.

The presence of several reaction units on the same reactivity probe can make it possible to increase the number of reaction data acquired in each conversion test of the probe in a given reaction medium. The database can thus be more rapidly filled. In addition, the presence of several reaction units can make it possible to demonstrate, if appropriate, the influence of the structural environment.

The reactivity probes used can be more particularly suitable for a given type of reaction.

For example, for a catalytic hydrogenation or other reactions, the probes can, for example, have at least one reaction unit chosen from the following units:

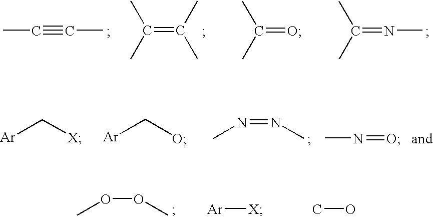

This highly reactive unit can be associated with at least one second unit, indeed even two other units, known on the other hand for a lower reactivity according to this same reaction, for example an aromatic ring or the nitrile functional group of a heterocycle. For example, for a given reactivity probe, it will be these less reactive units and their spatial arrangement which will constitute the structural environment associated with the most reactive reaction unit.

The number of probes is preferably chosen so as to represent the group of the chemical conversions capable of being involved in a given reaction. For example, for a hydrogenation, the different possibilities of aromatic or nonaromatic hydrocarbon unsaturation, the different carboxyl functional groups, COOH, CHO, CO, CONH₂, the carbimine functional groups, and the like, can be represented through these probes.

Mention may in particular be made, by way of illustration and without implied limitation of reactivity probes suitable for the invention, for example for the evaluation of the reactivity of a group of catalysts with respect to hydrogenation reaction, are those having the structures represented below:

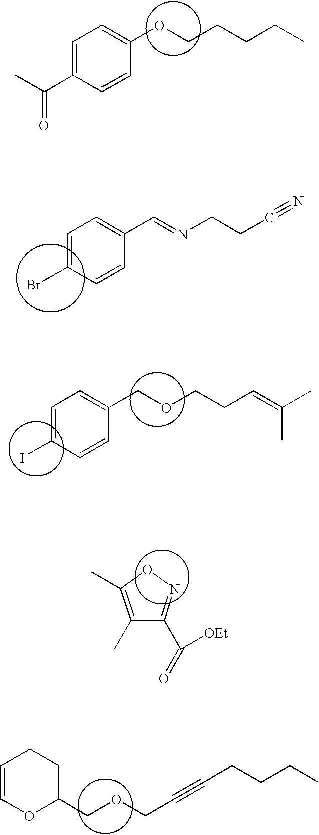

The database can additionally comprise information, associated with each catalyst and/or reaction unit listed, which can be highly varied and in particular the database can comprise data which inform about the activity of a portion at least of the catalysts listed for different reaction conditions, in particular the temperature of the reaction medium, the acidity, the pressure, the presence of solvents, the analytical method, and the like.

The database can be loaded onto a computer server where computers can be connected, for example a portable or stationary personal computer. The data can be recorded on a data medium.

The present invention also relates, according to another aspect, to a method for providing at least one catalyst which can be used to convert at least one reaction unit of at least one compound according to a given chemical reaction, characterized in that it comprises, in addition to stages x), y) and z) defined above, at least one stage of providing the catalyst or catalysts thus selected.

This stage of providing can, if appropriate, encompass a stage of manufacturing said catalyst.

The present invention also relates, according to another of its aspects, to a computer system which can be characterized in that it comprises means for:
i) making it possible to formulate at least one request relating to a chemical conversion in which at least one reaction unit of at least one compound is converted,
ii) identifying, in a database informing about the reactivity of a group of catalysts with regard to reaction units listed in the database, a listed reaction unit related to the unit to be converted,
iii) selecting, according to the listed reaction unit thus identified in the database and according to the conversion to be carried out, at least one catalyst having the reactivity required for the conversion and publishing this catalyst.

The term “publishing” should be understood as displaying, printing, recording in a file, remote transmitting or delivering.

A further subject matter of the invention is a method for selecting at least one catalyst which can be used for a given reaction, characterized in that the catalyst is selected according to the production yield of the reaction products which are assigned to at least one reactivity probe present in the database and converted according to said reaction.

The catalysts listed in the database can be of organic or inorganic chemical nature and in particular of organometallic nature or also of biological nature, such as proteins, cells or enzymes.

As it happens, they can be all the catalysts which can be used in homogeneous or heterogeneous organic synthesis.

The catalysts for chemical conversion comprise the majority of the elements of the Periodic Table and are solids, generally, under the usual reaction conditions.

Mention may in particular be made, by way of illustration and without implied limitation of these catalysts, of the catalysts based on bismuth, tin, nickel, palladium, antimony, ruthenium, titanium, zirconium, iridium, copper, cobalt, rhodium, platinum and rare earth metals.

These catalysts can be tested in isolation or in the form of combinations.

These catalysts can also be in a supported form. The type of support can be chosen from inert clays, from zeolites, from ceramics, from carbon or from an inert organic material. They can also be metal oxides, such as Al₂O₃. These supports can be employed in various solid forms, such as, for example, honeycombs, particles or networks.

Mention may in particular be made, by way of illustration and without implied limitation of the catalysts according to the invention, of the following catalysts: Pd/Al₂O₃; Pd/BaSO₄; Pd/CaCO₃, Pd/PEI; Pd/CaCO₃,Pd/C; Pt/C; Ru/C; Re/C; Rh/C; Rh/Al₂O₃; Ir/C; Ir/CaCO₃.

The catalysts may or may not be specific with regard to a biological or chemical reaction, for example a hydrogenation reaction.

The reactivity of the catalysts can be assessed in terms of yield and/or of selectivity. However, this catalytic activity can also be reflected by a lack of activity for the chemical conversion of a reaction unit and can be advantageous precisely on this account. Likewise, this reactivity can be reflected by the appearance of a specific selectivity in the reaction.

Generally, a catalyst is regarded as active within the meaning of the present invention when it makes it possible to carry out the chemical reaction under consideration with the satisfactory yield.

The database can inform about the reactivity of the group of the catalysts selected, with regard to the reactivity probes and the reaction units listed, for identical or different reaction conditions. This can make it possible to best assess the specificity of the catalysts and to thus optimize the knowledge of their performance in terms of effectiveness and in particular of selectivity.

The reaction conditions can be those generally used for the chemical reaction under consideration. They generally set the choice of a solvent medium, of its degree of dilution, of the coreactants, of a temperature, of a pressure and/or of the pH of the reaction medium.

The term “coreactant” denotes any compound which, by its presence in the reaction medium, is capable of participating in the reaction, such as carbon monoxide, for example, and/or of affecting the yield and/or the selectivity of the reaction. It can in particular be an acidic or basic compound or a chelating metal.

As it happens, it is by adjusting these parameters related to the reaction conditions that it may prove to be possible to control more precisely the nature of the product formed and/or to direct the selectivity of the reaction between two functional groups or even via the favored formation of one diastereomeric form of the product formed, the latter being or not being a final product.

The invention will be able to be better understood on reading the detailed description which will follow and on examining the appended drawing, in which:

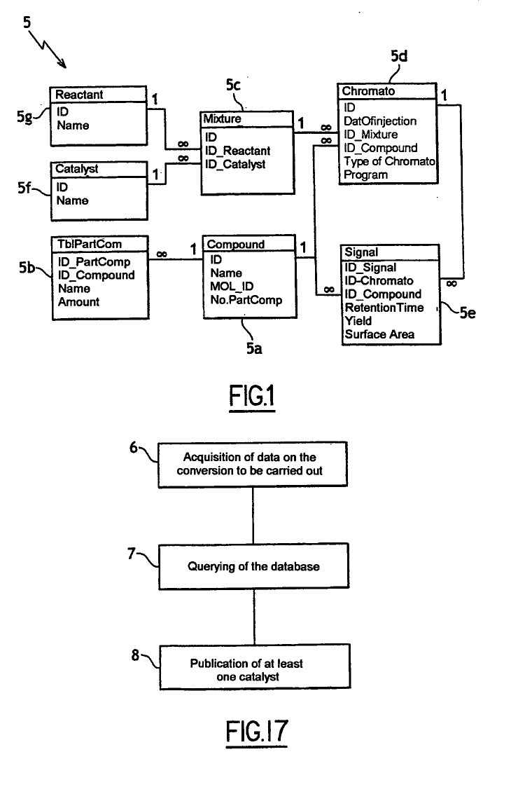

FIG. 1 diagrammatically represents different entities of a database in accordance with the invention,

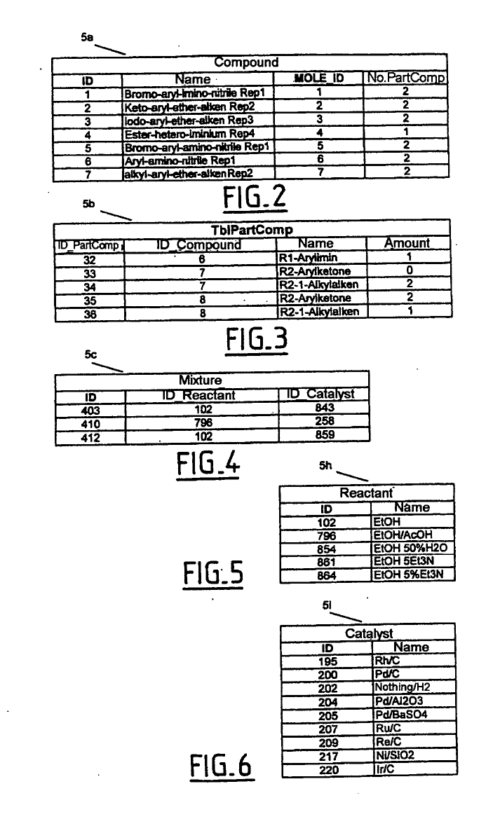

FIGS. 2 to 9 represent examples of entities of the database,

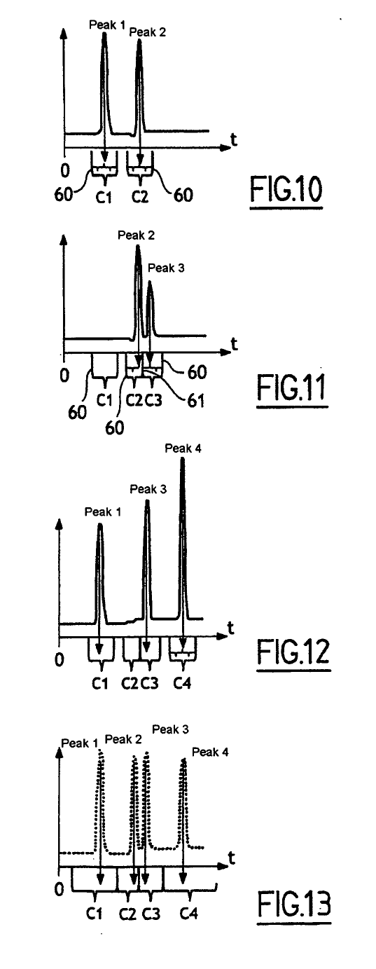

FIGS. 10 to 12 diagrammatically represent examples of chromatograms,

FIG. 13 represents a virtual chromatogram,

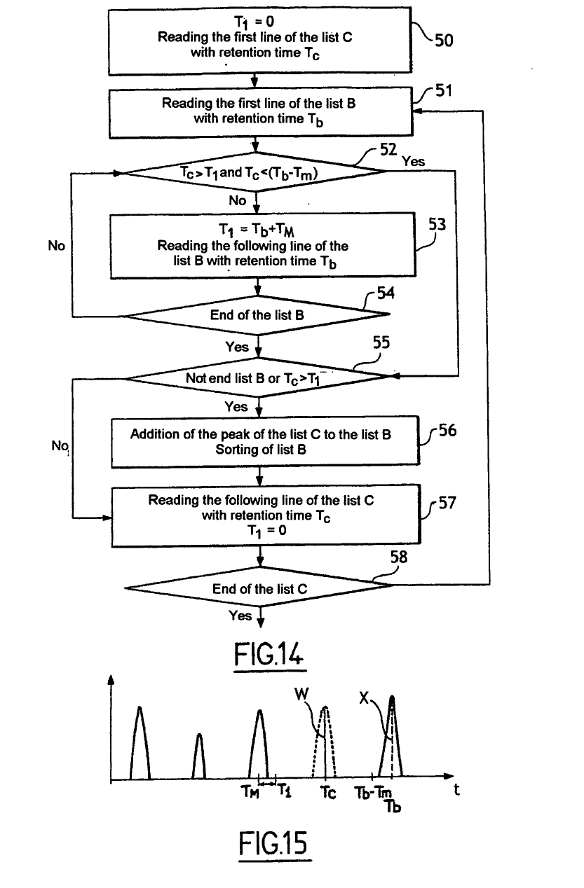

FIG. 14 is an example of an algorithm for the generation of a virtual chromatogram,

FIG. 15 represents an example of a virtual chromatogram obtained during the implementation of the algorithm of FIG. 14,

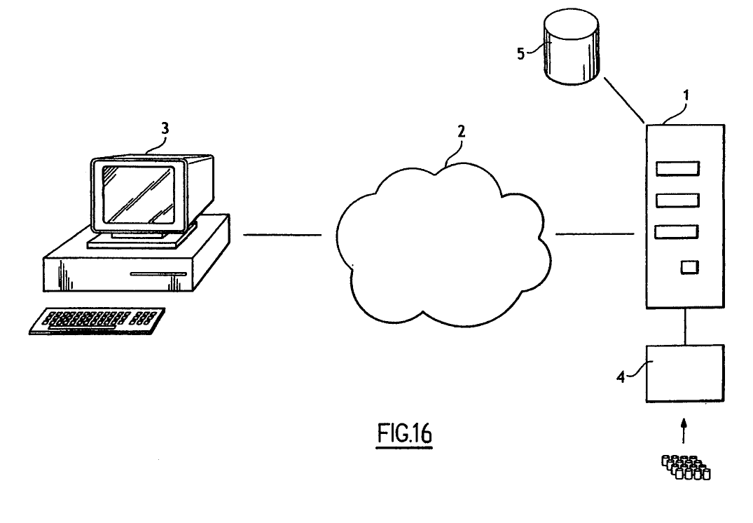

FIG. 16 diagrammatically represents a computer system which makes it possible to implement the invention,

FIG. 17 is a block diagram illustrating different stages of an implementational example of the method according to the invention,

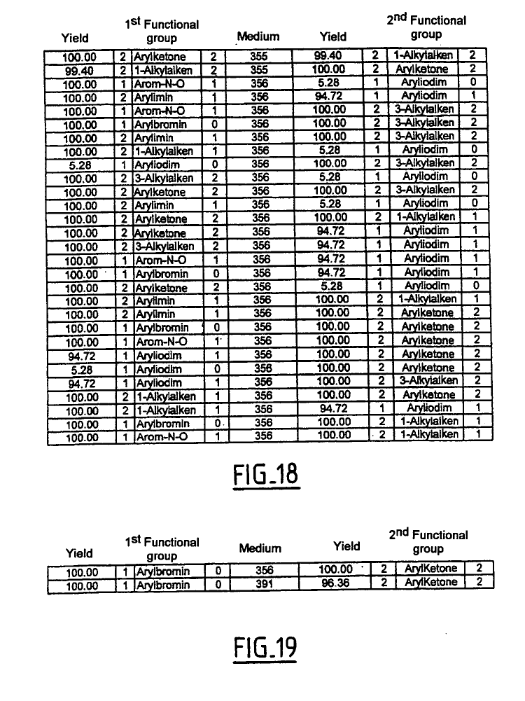

FIGS. 18 and 19 illustrate an example of the selection of reaction media following the formulation of a request.

FIG. 1 illustrates a relational database 5 in accordance with the invention, the entities 5a to 5g of which have been represented in a simplified manner.

The database 5 can store information, for example, in the form of tables composed of columns and lines.

FIG. 2 gives a partial representation of the entity 5a entitled “Compound”, in which are recorded, for each compound listed in the base, and among which appear in particular the reactivity probes, reaction units and reaction products, an identifier “ID”, for example a number, the name “Name” of the compound, the reference “MOLE_ID” of a table generated by a commercial tool, such as “Chem Draw”, comprising the drawing, the molecular weight, the empirical formula, and the like, and, if appropriate, the number of bonds “No.PartComp” capable of being modified during the reactions.

The database 5 also comprises an entity 5b entitled “Tb1PartComp” which comprises information relating to the reactivity indices of each compound listed in the entity 5a.

The entity 5b comprises a primary key “ID_PartComp”, the identifier “ID_Compound” of the compound to which the bonds belong, the name “Name” of each bond, it being possible for this name to comprise, for example, the number of the bond in the compound, and the state of the bonds “Amount”, it being possible for 0 to mean that there is no bond capable of being converted, the bond being, for example, C—H, it being possible for 1 to mean, for example, that the bond is of C—X or C═C type, it being possible for 2 to mean, for example, that the bond is of C≡C type, and the like.

In the example under consideration, a large number of experiments are carried out in order to test the reactivity of the reactivity probes in predefined reaction media and thus to create the database 5 with information of use regarding the properties of the catalysts listed in the database with regard to the reactivity probes.

These experiments can be carried out, for example, according to a standardized procedure using plates, also referred to as “blocks”, each comprising a plurality of wells, each plate being associated with a given reactivity probe, each well comprising a different reaction medium, that is to say comprising, for example, in addition to the reactivity probe, a specific catalyst, specific coreactants, if appropriate, specific solvents, and the like.

The entity 5c, entitled “Mixture”, makes it possible to record, in the base 5, information associated with a given reaction medium.

It is thus possible to record, in this entity 5c, for each reaction medium, as is seen in FIG. 4, a primary key “ID”, the identifier or identifiers “ID_Reactant” of the compound or compounds in the medium in which the reaction is carried out, each identifier being, for example, a number, the identifier “ID—Catalyst” of the catalyst used, the latter also, for example, being a number.

The identifiers “ID_Reactant” and “ID_Catalyst” refer, for example, to compounds referenced in the column “Name” in Table 5h “Reactant” and Table 5i “Catalyst”, represented partially in FIGS. 5 and 6.

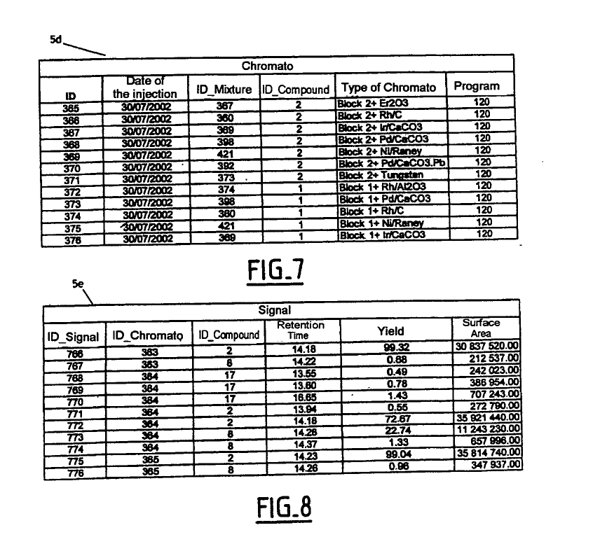

The database 5 additionally comprises entities “Chromato” 5d and “Signal” 5e, in which information related to the chromatographic analysis of the reaction media of the plates is recorded. These entities 5d and 5e have been partially represented in FIGS. 7 and 8.

The constituents of each well of a given plate are analyzed by liquid or gas chromatography and the entity “Chromato” makes it possible to retain the information of each chromatographic injection which corresponds to the result of a reaction.

FIGS. 10 to 12 represent three examples of chromatograms obtained by reacting the same reactivity probe in three different reaction media, which has made it possible to detect the presence of the compounds C₁ to C₄.

The entity 5d records, for example, as may be seen on examining FIG. 7, a primary key “ID”, the date of injection “Date of the injection”, the identifier “ID_Mixture” of the reaction medium, the particulars of which are known from the entity 5c, the identifier “ID_Compound” of the reactivity probe, the name and other characteristics of which are known from the entity 5a, and the name “Type of Chromato” of the analytical method used, which can be a number.

The entity 5e retains information of a chromatographic signal, that is to say of a chromatographic peak.

The entity 5e records, for example, as can be seen on examining FIG. 8, a primary key “ID_Signal”, the identifier “ID_Chromato” of the chromatogram to which the peak belongs, the identifier “ID_Compound” of each compound corresponding to a signal, the retention time “Retention Time”, expressed, for example, in minutes and hundredths of a minute, the yield “Yield”, expressed, for example, as percentage, and the area “Surface Area” of the peak.

The entities 5d and 5e can be loaded automatically from at least one result file generated automatically by the chromatograph.

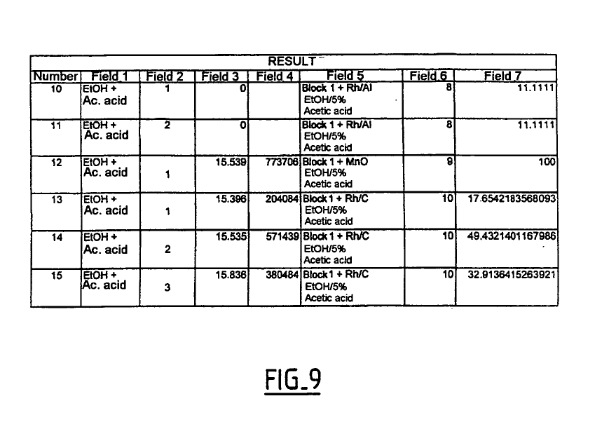

Such a file can, for example, be provided in the form of the table “Result” partially represented in FIG. 9.

This table comprises a column “Number”, which comprises the number of the lines of the table, and seven fields in which are respectively recorded, for field 1, the name of the reactants, for field 2, the sequence number of the signal in the chromatogram, for field 3, the retention time, for field 4, the surface area of the signal, for field 5, the catalyst and the name of the analysis, for field 6, the number of the analysis and, for field 7, the yield.

In order to calculate the yield, first the sum S of the areas which appear in the column of field 4 and which correspond to the same analysis, that is to say which have the same analysis number in field 6, is calculated.

Subsequently, for a given line, the value carried in the column of field 7 is equal to 100 times that carried in the column of field 4, divided by S.

No calculation of yield is made when the values which appear in the column of field 3 are zero.

The entity 5d can be loaded automatically from the file “Result”. The identifier “ID” is incremented automatically at each new analysis recorded in the base, the column “Type of Chromato” can be filled by the data appearing in field 5 of the table “Result”, the column “Date of the injection” can be taken as the same as the date of the day and the number carried in the column “ID_Mixture” is obtained by treating fields 1 and 5. The columns “Program” and “ID_Compound” of the entity 5d can be filled during the preparation of the plates.

The entity 5e can also be filled automatically, the identifier “ID_Signal” being, for example, a number incremented automatically at each new analysis recorded in the base, the identifier “ID_Chromato” is taken as the same as the number “ID” of the last analysis treated, the column “Retention Time” is filled from the data appearing in field 3 of the table “Result”, likewise for the column “Surface Area”, which corresponds to field 4 of the table “Result”, and the column “Yield”, which corresponds to field 7 of the table “Result”.

As regards the filling of the column “ID_Compound” of the entity 5e, that is to say the assigning of a chemical compound to each signal of the chromatogram, the following procedure can be carried out.

All the signals obtained with the same analytical method, that is to say having the same number in the column “Program” of the entity 5d, and the same reactivity probe, that is to say the same number in the column “ID_Compound” of the entity 5d, can be assigned to a virtual chromatogram which would have been obtained by an imaginary experiment giving in one go all the conversion products of a given reactivity probe.

The virtual chromatogram is advantageous insofar as it makes it possible to automatically assign, over a large number of signals, a compound to each peak.

Once specific compounds are associated with all the signals of this virtual chromatogram, the corresponding compound can be allocated to any comparable signal obtained with the same analytical method. This can make it possible to facilitate the analysis of the result of the reaction for a new catalyst or different operating conditions, since it is not necessary to carry out the chemical analysis of the compounds having retention times substantially coincident with those of the compounds already analyzed. This method of analysis makes it possible to rapidly create the database.

A highly diagrammatic example of a virtual chromatogram, created from the signals of the chromatograms of FIGS. 10 to 12, has been represented in FIG. 13.

An example of a method which makes it possible to generate such a virtual chromatogram will now be described.

First of all, a first list A is generated from the data of the entities 5d and 5e with all the lines which relate to the same reactivity probe, that is to say which have the same identifier “ID_Compound” in the entity 5d, and the same analytical method, that is to say the same number for “Program”.

This list is sorted in the decreasing direction of the number of signals present in each analysis, that is to say having the same number in the column “ID_Chromato”.

The peaks representing less than 5% of the total surface area of the peaks of an analysis are regarded as insignificant and no attempt is made to allocate a compound to them.

Subsequently, a second list B is generated with all the signals of the first analysis of the list A, that is to say that comprising the greatest number of peaks. This second list B is sorted in the increasing direction of the retention times.

Subsequently, a third list C of all the signals present in all the analyses of the list A is drawn up and the virtual chromatogram is generated by supplementing the list B according to the algorithm of FIG. 14.

This algorithm is made use of with a given value for the minimum time Tₘ tolerated between two signals in order to regard them as separate. A low value for Tₘ results in a chromatogram with many signals, while a high value generates a chromatogram having few signals. Tₘ is, for example, equal to 0.2 min.

In stage 50, the signals of the list C are read sequentially and a retention time variable T₁ is given an initial value of 0.

In stage 51, for each signal W of the list C thus read, of retention time T_{c}, sequential reading of the signals of the list B takes place, a retention time T_{b} being associated with each signal x of this list.

In stage 52, it is determined if the retention time T_{c} of the signal W of the list C being read is greater than T₁ and smaller than the retention time T_{b} of the signal X of the list B being read minus Tₘ.

If this is not the case, the next stage becomes stage 53, during which the value T_{b}+Tₘ is allocated to the variable T₁ and the following signal X of the list B, of corresponding retention time T_{b}, is read. Subsequently, in stage 54, if the list B is not finished, a return is made to stage 52.

If, in stage 52, the retention time T_{c} is greater than T₁ and the retention time T_{c} is less than T_{b}−Tₘ, which corresponds, for example, to the situation of FIG. 17, the next stage becomes stage 55, during which it is confirmed that the list B is not finished or that T_{c} is greater than T₁.

If this is the case, in stage 56, the peak W is added to the list B and the latter is again sorted.

Subsequently, in stage 57, the following signal W of the list C, of corresponding retention time T_{c}, is read and T₁ is given an initial value of 0. In the following stage 58, it is confirmed that the list C is not finished and, if such is the case, a return is made to stage 51.

If the test gives a negative result in stage 55, an advance is made directly to stage 57.

Once the virtual chromatogram has been generated, a retention time range can be allocated to each compound, taking, for example, as lower limit of each range, half the sum of the retention times of the peak concerned and of that which precedes it.

Each peak of a chromatogram can be associated, as can be seen in FIG. 10, with a temporary time range 60 which, in the case of FIG. 10, is centered on the tip of the peak concerned and has an extent in time on both sides of the tip of the peak corresponding to the minimum time Tₘ tolerated between two signals. When two peaks are separated by at least this minimum time Tₘ but by less than twice this minimum time, the temporary ranges 60 assigned to the compounds corresponding to these peaks exhibit a boundary 61 corresponding to the middle of the interval between the retention times corresponding to the tips of the peaks, as can be seen in FIG. 11.

The database 5 can thus be drawn up. The database 5 can be queried so as to reply to requests relating to the reaction units listed.

A method according to the invention is advantageously implemented using a computer system which can comprise, as illustrated in FIG. 16, a computer server 1 connected via a network 2 to a user terminal 3. The network 2 is, for example, an Intranet or Internet network.

The computer server 1 can additionally be connected to a data acquisition system 4, it being possible for this system to comprise a manipulator arm and an analytical device, such as, for example, a gas or liquid chromatograph. This analytical device provides data on each reaction medium after reaction, as will be specified later.

The computer server 1 comprises or can access conventional data storage means and in particular can be capable of communicating with other computers, via the network 2 or via other networks.

The terminal 3 is, for example, a computer of PC type connected by a telephone line or other connection to the network 2.

In accordance with one aspect of the invention, the server 1 is arranged in order to make possible, in a first stage 6, as illustrated in FIG. 17, the acquisition of data relating to the chemical conversion to be carried out, in order to query, in a second stage 7, a relational database 5, the entities 5a to 5g of which have been represented in a simplified way in FIG. 3, and to make possible the publishing, in a third stage 8, of at least one catalyst having a utility in carrying out the conversion.

FIG. 18 represents an extract of a data field originating from the database 5, each line of which comprises information relating to the yield of the conversion of two reaction units, the names of which are carried in the columns entitled “1^{st} Functional Group” and “2^{nd} Functional Group”, in the presence of a reaction medium, the identifier of which is carried in the column entitled “Medium”. The state of the bonds is carried on both sides of the name of the reaction unit. The same number on the left and on the right of the name of the reaction unit means that the latter has not been converted. The decrease by one unit means, for example, that a reduction has taken place. The FIG. 2 indicates, for example, that the reaction unit is still capable of undergoing a reduction. The FIG. 0 indicates, for example, that bond breaking has occurred and thus that the reaction unit is no longer capable of undergoing a further reduction stage. The FIG. 1 indicates that the compound is capable of being converted and in particular reduced, depending on the nature of the bond. In the example of the first line of the table of FIG. 18, it should be understood that the reaction unit “Arylketone” has not reacted and that the reaction unit “1-Alkylalkene” has only very slightly reacted, since this reaction unit has remained unchanged with a yield of 99.4%.

In the example of the third line of the table, the reaction unit “Aryliodim” has undergone a reduction with a yield of 5.28%, the iodine having been replaced by hydrogen.

A request relating to two reaction units present in the same reaction medium can be formulated, it being indicated for each reaction unit whether or not it is desired for the latter to react.

The request can, for example, be formulated so as to look for reaction media which make possible the reduction of a reaction unit “Arylbromide” without reducing a reaction unit “Arylketone”.

FIG. 19 represents two result lines corresponding to this request. It is seen that the reaction media 356 and 391 make possible the reduction of the unit “Arylbromin”, since the reactivity index has changed from 1 to 0, while leaving unchanged the reaction unit “Arylketone”, completely for the reaction medium 356 and with a yield of 96.36% for the reaction medium 391. The knowledge of the reaction medium makes it possible to go back to the catalyst present in the latter.

On returning to FIG. 16, the acquisition of data in stage 6 can take place, for example, via the terminal 3 after connection to the server 1 and identification, if appropriate, of the user by an access code. The user can be itself a computer system programmed to search for relevant information on a computer network.

The reaction to be accomplished can be entered in a keyboard or using a mouse, for example on the terminal 3, or in the form of an image file or other, and the data entered can in particular comprise the starting compound or compounds and the desired final compound or compounds.

The following stage 7 can comprise the breakdown into reaction units of the compounds involved in the reaction and the identification of the reaction units which undergo a conversion and, if appropriate, those which are retained. This breakdown can be carried out automatically by a computer system and in particular the server 1, so as to make possible formulation internal to the computer system 6 of a request comprising the identity of the reaction units concerned and, for each of them, the variation in the reactivity index, in order to obtain, from the database, the name or names of the appropriate catalysts.

For example, in the case where the reaction is a hydrogenation of a compound of formula (I) as follows: 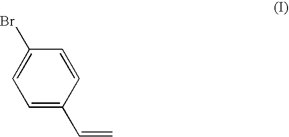
the computer system can make it possible to identify two reaction units, namely an ethylenic bond and a carbon-bromine bond.

Reaction units related to these, present on reactivity probes, are listed in the database 5.

For example, the probe No. 1 below comprises the carbon-bromine bond reaction unit and the probe No. 2 the ethylenic bond reaction unit.

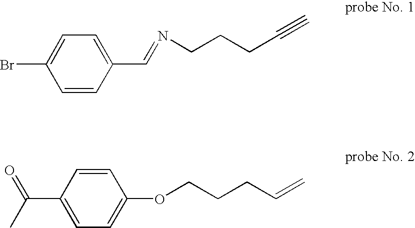

The database 5 comprises information on the reactivity of the catalysts listed, in particular the conversion yield, for each of the reaction units of the probe under consideration.

For example, the reactivity of several catalysts with regard to the conversion of the reaction units was tested for each of the two probes, being reported below in table I for the probe No. 1 and in table II for the probe No. 2. It can be seen that the catalysts Pd/C, Pt/C, Pd/Al₂O₃, Pd/BaSO₄, Pd/CaCO₃, Pd/CaCO₃.Pb and Ir/CaCO₃ are effective in reducing the ethylenic bond unit and the same catalysts Pd/C, Pd/Al₂O₃, Pd/BaSO₄ for the reduction of the carbon-bromine bond of the bromide unit.

TABLE I
(probe No. 1)

| | Carbon-bromine |
|---|---|
| Catalyst | bond reduction |
| Er₂O₃ | — |
| Pt/C | — |
| Pt/C, AcOH | — |
| Pd/C | 100% |
| Pd/Al₂O₃ | 100% |
| Pd/BaSO₄ | 100% |
| Pd/CaCO₃ | — |
| Pd/CaCO₃•Pb | — |
| Pd/Poly | — |
| Ni/SiO₂•Al₂O₃ | — |
| Ru/C | — |
| Re/C | — |
| Rh/C | — |
| Rh/Al₂O₃ | — |
| Ir/C | — |
| Ir/CaCO₃ | — |

TABLE II
(probe No. 2)

| | Ethylenic |
|---|---|
| Catalyst | bond reduction |
| Er₂O₃ | 1% |
| Pt/C | 97% |
| Pd/C | 99% |
| Pd/Al₂O₃ | 100% |
| Pd/BaSO₄ | 96% |
| Pd/CaCO₃ | 96% |
| Pd/CaCO₃•Pb | 100% |
| Pd/Poly | 1% |
| Ni/SiO₂•Al₂O₃ | 1% |
| Ru/C | 15% |
| Re/C | 1% |
| Rh/C | 70% |
| Rh/Al₂O₃ | 23% |
| Ir/C | 8% |
| Ir/CaCO₃ | 95% |

Table III below reports a close correlation between the predictive reactivity data acquired using the reactivity probes and the reactivities confirmed experimentally by carrying out the hydrogenation of the compound of formula (I) with the seven catalysts identified above.

TABLE III

| | Probe 1 | | | Compound |
|---|---|---|---|---|
| | Carbon- | Probe 2 | Compound (I) | (I) |
| | bromine | Ethylenic | Carbon- | Ethylenic |
| | bond | bond | bromine bond | bond |
| Catalyst | reduction | reduction | reduction | reduction |
| Pd/C | 1 | 1 | 1 | 1 |
| Pd/BaSO₄ | 1 | 1 | 70% | 1 |
| Pd/Al₂O₃ | 1 | 1 | 1 | 1 |
| Pt/C | 0 | 1 | 0 | 1 |
| Pd/CaCO₃ | 0 | 1 | 30% | 1 |
| Pd/CaCO₃•Pb | 0 | 1 | 0 | 40% |
| Ir/CaCO₃ | 0 | 1 | 0 | 1 |

Note:
1 = 100% of the yield
0 = <5% of the yield

The computer system 1 makes it possible to determine the catalyst or catalysts capable of carrying out the conversions desired for the reaction units identified.

In the case where several catalysts are suitable, a single effective catalyst can be published according, for example, to criteria such as the commercial availability of this catalyst or the cost of the catalyst.

For example, if the catalysts Pd/Al₂O₃ and Pd/C are suitable and only the catalyst Pd/Al₂O₃ is available from a company queried by the computer system, then only this catalyst is published in response to the request formulated by a user. The catalyst can, if appropriate, be sent physically to the user, indeed even be manufactured on request. If appropriate, the catalyst can be sent with a specific packaging which facilitates the carrying out of tests.

The computer system can publish, in addition to the structure of the catalyst, its name, its cost, its effectiveness and its specificities in terms of selectivity.

In the example which has just been given, the responses to the requests formulated by the user are provided by the server 1, but the scope of the present invention is not departed from if the computer system is reduced to a single computer on which an application is run. In this case, the application can, for example, be downloaded on a distant site or be present on a data medium, such as, for example, an optical disk, and be loaded onto the computer.

Throughout the description, including the claims, the expression “comprising a” should be understood as being synonymous with “comprising at least one”, unless otherwise specified.

1. A method for creating a database which makes it possible in particular to select at least one catalyst suitable for a reaction, this method comprising the following stages:
a) preparing a plurality of different reaction media comprising the same reactivity probe and each comprising at least one catalyst,
b) analyzing, by an analytical method, each reaction medium after reaction,
c) assigning a result of the analysis according to stage b) to the reactivity probe in the database, this result characterizing the different reaction products obtained from this reactivity probe,
the database being a relational database comprising a first entity in which is recorded information relating to the reaction units listed in the base, a second entity comprising information relating to the state of the bonds of at least one reaction unit listed in the first entity, a third entity in which is recorded information associated with the different reaction media and at least one fourth entity in which is recorded information related to the analytical results of the reaction media on conclusion of a reaction.

2. A method for creating a database which makes it possible in particular to select at least one catalyst suitable for a reaction, this method comprising the following stages:
a) preparing a plurality of different reaction media comprising the same reactivity probe and each comprising at least one catalyst,
b) analyzing, by an analytical method, each reaction medium after reaction,
c) assigning a result of the analysis according to stage b) to the reactivity probe in the database, this result characterizing the different reaction products obtained from this reactivity probe,
reaction units being listed individually in the database, the units being present on the reactivity probes, and
for at least a portion of the reaction units listed, information is associated with each unit listed, in particular on the states of the bonds, targeted at describing the degree of reactivity of the bonds which are associated with it.

3. A method for creating a database which makes it possible in particular to select at least one catalyst suitable for a reaction, this method comprising the following stages:
a) preparing a plurality of different reaction media comprising the same reactivity probe and each comprising at least one catalyst,
b) analyzing, by an analytical method, each reaction medium after reaction, the result of the analysis characterizing different reaction products obtained from this reactivity probe,
c) assigning a result of the analysis according to stage b) to the reactivity probe in the database, reaction units being listed individually in the database, the units being present on reactivity probes, the database comprising information which informs about the influence of the structural environment of a listed reaction unit on its reactivity.

4. The method as claimed in claim 1, wherein the plurality of different reaction media comprises at least two reaction media comprising different catalysts.

5. The method as claimed in claim 1, wherein the analytical method is a liquid or gas chromatography method.

6. The method as claimed in claim 1, wherein stages a) to c) are repeated for a plurality of different reactivity probes and/or a plurality of different reaction media.

7. The method as claimed in claim 1, wherein, for one reactivity probe at least, a file is generated collating the group of the results covering all the conversions which have been carried out on said probe.

8. The method as claimed in claim 1, wherein the reactivity probe comprises at least one reaction unit.

9. The method as claimed in claim 1, wherein the reaction media are chosen in order to carry out at least one of the following reactions: reactions for the formation or breaking of bonds, in particular C—C; —CO; —CN; C═N; C═C bonds.

10. A method for selecting at least one catalyst of use in the chemical conversion of at least one reaction unit, comprising:
x) acquiring data relating to said conversion and, if appropriate, to the structural environment of the reaction unit to be converted,
y) identifying, in a database informing about the reactivity of a group of catalysts with regard to reaction units listed in the database and present on reactivity probes, at least one listed reaction unit related to the unit to be converted,
z) selecting, in the database, according to the listed reaction unit thus identified, on the one hand, and the conversion to be carried out, on the other hand, at least one catalyst having the reactivity required for the conversion.

11. The method as claimed in claim 10, wherein the said database was created according to a method comprising:
a) preparing a plurality of different reaction media comprising the same reactivity probe and each comprising at least one catalyst,
b) analyzing, by an analytical method, each reaction medium after reaction,
c) assigning a result of the analysis according to stage b) to the reactivity probe in the database, this result characterizing the different reaction products obtained from this reactivity probe,
the database being a relational database comprising a first entity in which is recorded information relating to the reaction units listed in the base, a second entity comprising information relating to the state of the bonds of at least one reaction unit listed in the first entity, a third entity in which is recorded information associated with the different reaction media and at least one fourth entity in which is recorded information related to the analytical results of the reaction media on conclusion of a reaction.

12. The method as claimed in claim 10, wherein the conversion takes place during a chemical reaction chosen from halogenation, reduction, hydrogenation, oxidation, hydrolysis, dehydration or esterification reactions, acidic or basic catalytic reactions, metallocatalyzed multicomponent reactions, trimerization reactions, reactions for the formation of heterocycles, pericyclic reactions or thermal and/or photochemical reactions.

13. The method as claimed in claim 10, wherein the conversion is chosen from: reduction of imine to give amine, cleavage of a benzyl C—N or C—O bond, reduction of a halide, reduction of a nitro functional group to give amine or of a nitrile to give amine, reduction of amide, reduction of an alkyne unit, reduction of a ketone to give alcohol, reduction of a ketone to give alkane and cleavage of an ether unit.

14. The method as claimed in claim 10, wherein the acquisition of the data in stage a) comprises the formulation of a request mentioning the reaction unit concerned and the nature of the conversion to which it is desired to subject it.

15. The method as claimed in claim 10, wherein the conversion is formulated by indicating the variation in the state of the bonds of the functional groups to be converted or to be retained in each reaction unit resulting from the conversion or the difference in the state of the bonds in the reaction unit under consideration between the states before and after conversion.

16. The method as claimed in claim 10, wherein the acquisition of data comprises the formulation of a request relating to the conversion and/or the nonconversion of at least two different reaction units.

17. The method as claimed in claim 10, wherein, in the case of a first reaction unit to be converted and of a second reaction unit not to be converted, this first reaction unit and this second reaction unit being present on a starting compound, the request is targeted at selecting a catalyst capable of carrying out the conversion of the first unit with a satisfactory yield while leaving the second intact or at the very least converting it to a sufficiently insignificant extent.

18. The method as claimed in claim 10, wherein the acquisition of data in stage a) is carried out by formulating a request for the conversion of at least one starting compound, the method comprising the analysis of the starting and final compounds for the purpose of identifying the reaction unit or units which react and that or those which do not react.

19. The method as claimed in claim 10, comprising:
the breakdown into different substructures of a starting compound involved in a reaction,
the identification of the reaction unit or units to be converted and, if appropriate,
the identification of the reaction unit or units which have to be retained.

20. The method as claimed in claim 1, wherein the reaction unit is chosen from: 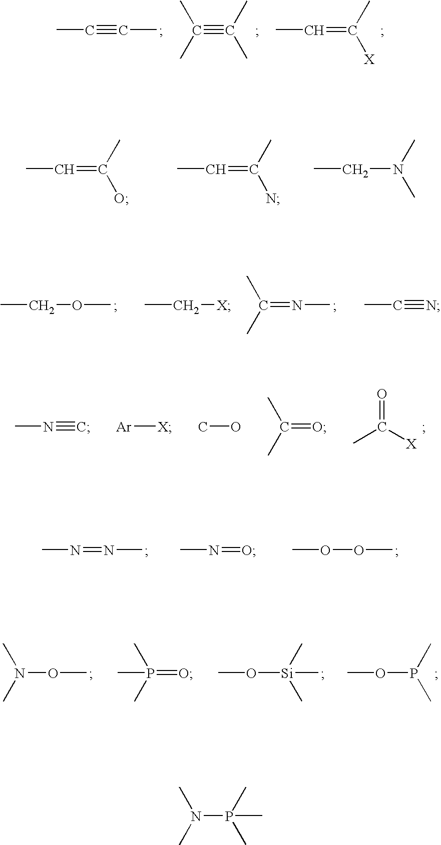
with X representing a halogen atom.

21. The method as claimed in claim 1, wherein the database comprises, for each catalyst listed, information relating to the reaction medium in which it was tested for its catalytic activity.

22. The method as claimed in claim 1, wherein, for at least a portion of the reaction units listed in the database, information is associated with each unit listed targeted as describing the state of the bonds which are associated with it.

23. The method as claimed in claim 2, wherein the state of the bonds is an integer ranging from 0 to 3.

24. The method as claimed in claim 1, wherein the database comprises information which informs about the influence of the structural environment of a listed reaction unit.

25. The method as claimed in claim 1, wherein the database comprises data which inform about the activity of a portion at least of the catalysts listed according to different reaction conditions, in particular the temperature of the reaction medium, the acidity, the pressure, the presence of solvents or the analytical method.

26. A method for providing at least one catalyst which can be used to convert at least one reaction unit of at least one compound according to a given chemical reaction, characterized in that it comprises, in addition to stages x), y) and z) defined in claim 10, at least one stage of providing the catalyst or catalysts thus selected, and in particular the manufacture of said catalyst.

27. A method for creating a database which makes it possible in particular to select at least one catalyst suitable for a reaction, this method comprising the following stages:
a) preparing a plurality of different reaction media comprising the same reactivity probe and each comprising at least one catalyst,
b) analyzing, by an analytical method, each reaction medium after reaction,
c) assigning a result of the analysis according to stage b) to the reactivity probe in the database, this result characterizing the various reaction products obtained from this reactivity probe.
